(19) United States
(12) Patent Application Publication
(10) Pub. No.: US 2008/0191597 A1
(43) Pub. Date: Aug. 14, 2008

(54) Method of Operating a Flow-Through Plasma Device

(75) Inventors: Christian Vauge, Paris (FR); Pierre Sagnet, Noisy-le-Roi (FR)

Correspondence Address: SHOEMAKER AND MATTARE, LTD, 10 POST OFFICE ROAD - SUITE 110, SILVER SPRING, MD, 20910, US

(73) Assignee: ASKAIR TECHNOLOGIES AG, Zürich (CH)

(21) Appl. No.: 11/817,994

(22) PCT Filed: Feb. 27, 2006
(86) PCT No.: PCT/EP2006/060294

§ 371 Date: Sep. 7, 2007

(30) Foreign Application Priority Data
Mar. 9, 2005 (EP) 05101837.2

(51) Int. Cl. H05H 1/24

(52) U.S. Cl. 313/231.31

(57) ABSTRACT

The present invention concerns a method of operating a flow-through plasma device (1) with at least one plasma-generating section (2), preferably multiple plasma-generating sections (2A,2B) in series, for the treatment of a preferably gaseous medium (3), comprising the steps of: Determining at least one characteristic (C) of said treated or untreated medium (3); and dependent on said determined characteristic (C), altering at least one operation setting (S) of said plasma device (1).

The invention relates to a flow-through plasma device, a method of operating such a flow-through plasma device, as well as a method of treating a preferably gaseous medium according to the features of the independent claims.

Various methods of plasma generation and a vast variety of applications of such plasmas are known in the art, e.g. reviewed by Bogaerts et al., Spectrochimica Acta Part B 57 (2002) 609-658.

Corona discharge plasma has been suggested for the destruction of airborne microbes and chemical toxins, e.g. in U.S. Pat. No. 5,814,135. The device according to U.S. Pat. No. 5,814,135 possesses a point-to-grid geometry of the plasma-generating section, wherein either the positive or negative pole of a power supply is connected to the point; thus, a positive or a negative corona plasma is generated. A major drawback of such devices is the significant production of nocuous emissions such as ozone (O₃), nitric oxides (NOₓ), etc., which is only hardly to keep below critical values; moreover, electric efficiency is often not satisfactory, and the functions of the device are not individually adaptable in order to fit specific environmental situations, e.g. a specific medium to be treated. Additionally, especially corona plasmas are highly non-uniform and unstable, thus allowing for a significant amount of contaminants to pass such devices without being eliminated.

The possibility of modulating the AC of plasma-electrodes, dependent on the contamination niveau of the medium to be treated as determined at the entry of the device, has been mentioned in WO 03/092338 for a highly complex plasma-device. However, such modulations are technically complicated to achieve, and suitable modulations for this purpose only hardly to be determined. Moreover, the efficiency of such modulations on the treatment result is often not satisfactory.

It is thus an object of the present invention to overcome at least some of the drawbacks of the prior art, i.e. to provide a flow-through plasma device and a method of operating such device, which is adaptable to a specific media to be treated and/or specific environmental conditions or industrial/medical applications conditions at which the device is operated.

This object is solved inter alia by a method of operating a flow-through plasma device with at least one, preferably multiple (i.e. two or more) plasma-generating sections in series, for the treatment of a preferably gaseous medium, comprising the steps of:
Determine at least one characteristic of said medium;
Dependent on said at least one determined characteristic, altering at least one operation setting of said plasma device, wherein said alteration of at least one operation setting is not a modulation of the alternating current or voltage supplied to plasma-electrodes.

As used herein, a flow-through plasma device is understood as a device which is actively (by a fan or the like) or passively (e.g. driven by the electric wind generated by a plasma inside the device) fed with a preferably gaseous medium flowing through the device, thereby at least partially getting in contact with at least one plasma generating section.

A characteristic of said medium may be either a physical characteristic, a chemical characteristic or a biological characteristic of said medium. Such characteristic may e.g. be, but not limited thereto, temperature, spectral absorption and/or emission, moisture content, droplet size, particle content, particle size, a biological activity and/or contamination such as a viruses, bacteria, spores, etc., the composition of said medium or an indication of said composition, a spectroscopic property, the presence and/or quantity of a compound or species, etc.

A plasma generating section is understood herein as such part of the device, where a plasma, preferably a corona plasma, is being established, i.e. a single pair of electrodes (e.g. tip vs. plate or grid) generating a plasma, or a set of electrodes arranged in a cross-sectional volume of a flow-through passage of the device.

As used here and henceforth, determination of a physical/chemical/biological characteristic is to be understood as involving a simple measurement (such as e.g. of a temperature, of a flow-through velocity or the like, of a spectral absorption) as well as an analysis involving a further implication (e.g. of the presence and/or the fraction of a compound, of the composition of the medium, of the biological activity (such as e.g. infectiveness, or the like), etc.).

According to the invention, it was surprisingly found that by simply altering at least one operation setting of said plasma device, dependent on at least one determined characteristic of a medium to be treated by a flow-through plasma device, and avoiding the above-mentioned disadvantageous modulation of the electric supply of plasma electrodes, the efficiency of the device is strikingly enhanced, and especially the output of said device is easily controlled with respect to specific treatment needs, as the case may be the sterilization of a gaseous medium, as e.g. indicated by a selected characteristic of said medium. Moreover, with the operation setting being specifically adaptable to the given treatment problem of a preferably gaseous medium, one and the same device is versatile for a great variety of applications by altering at least one operation setting.

According to another embodiment of the present invention, altering of said operation setting comprises a step chosen from the group consisting of adjusting an electrical parameter of said plasma device, supplementing said preferably gaseous medium with a chemical compound, subjecting said preferably gaseous medium to irradiation, heating or cooling of said preferably gaseous medium, and combinations thereof.

The chemical compound, which is supplemented to the preferably gaseous medium, may be chosen by the person of routine skill in the art e.g. by routine experiments in order to allow for an improvement in the treatment of the specific gaseous medium. The chemical compound may either act independently from the reactive plasma species on the preferably gaseous medium, but preferably acts synergistically with the reactive plasma species on the preferably gaseous medium. Most preferably, the chemical compound interacts with at least one of the reactive plasma species to give rise in further reactive species. The chemical compound is preferably chosen from the group consisting of electronegative gases such as e.g. oxygen; electropositive gases such as e.g. helium, or noble gases; vapour of polar liquids such as e.g. vapour of water; and mixtures thereof. Although the invention is not being limited by the following explications, electronegative gases such as e.g. oxygen or carbon dioxide will capture electrons in the plasma, therefore modifying the mobility of negative charge carriers and the conductivity of the ionised medium. On the other hand, electropositive gases such as e.g. helium or noble gases will modify the mobility of positive charge carriers and the conductivity of the ionised medium. Moreover, vapour of polar liquids such as e.g. water, whose molecules are attracted by an electric charge, may modify the mobility of charge carriers of either sign and the conductivity of the ionised medium. The suitable choice of an appropriate chemical compound can be either performed manually or, preferably, automatically. In any case, the person of routine skill in the art may, in knowledge of the present invention, choose an appropriate chemical compound or a combination of such compounds, based on the specific treatment problem, by routine experiments, if necessary.

The irradiation may also be chosen by the person of routine skill in the art e.g. by routine experiments in order to allow for an improvement in the treatment result of the preferably gaseous medium. Most preferably, the irradiation is chosen from the group consisting of the UV spectral range. The UV spectral range is understood herein as to comprise the spectral wave-length of about 380 to about 10 nm. In any case, such irradiation is preferably applied which is absorbed by excitation of valence electrons, leading to dissociation and/or ionisation of atoms and/or molecules and therefore modifying the conductivity of the ionized medium, due to the creation of charges of either sign. A similar effect can be obtained by other ionising radiations or particle beams such as e.g. X rays, gamma rays, neutron or electron beams. However, UV irradiation is preferred for practical reasons, as the latter ionising radiations are difficult to implement in usual situations.

According to an especially preferred embodiment, said irradiation is performed with the light emitted by an external plasma source, e.g. a glow discharge (e.g. separated from the flow-through channel by a suitable window or the like), created in one or more of the gases of the medium to be treated (e.g. oxygen or nitrogen in the case of air to be treated by the device). In this case, the photons emitted by the external plasma source, e.g. a glow discharge, have their wavelengths exactly tuned to interact with the excited states of the atoms and/or molecules of the plasma(s) in the flow-through passage, therefore modifying the chemical reactivity inside the flow-through device.

The adjusted electrical parameter may also be chosen by the person of routine skill in the art e.g. by routine experiments in order to allow for an improvement in the treatment of the specific gaseous medium. Preferably, the adjusted electrical parameter is a setting of an AC or DC power supply, connected to the plasma generating electrodes. Suchlike, single plasmas may be turned on or off, depending on the specific treatment problem (e.g. dependent on the determined characteristic of said preferably gaseous medium), and/or the intensity of a plasma may be varied and controlled. Most preferably, the adjusted electrical parameter is a voltage and/or current, and/or a frequency and/or an amplitude thereof, respectively, which is supplied to an electrically conducting electrode in or nearby the flow-through passage of said device, which electrode is not a tip- or counter-electrode for the generation of a plasma. The range of possible variations of these parameters is evident to the person of routine skill in the art and/or can be determined by routine experiments, dependent on the specific medium to be treated and the specific design of the device, especially the plasma-electrode-configuration. In general terms, suitable values are fenced in by minimal values which are necessary for a generation of a plasma at all, and maximum values which are not being exceeded because otherwise leading to formation of an arc. Such an electrode or a plurality of such electrodes may deflect and/or attract or even absorb charged particles and/or ions (either re-active plasma species or species of the preferably gaseous medium to be treated or derived thereof), dependent on the operation setting of a suitable power supply which is connected to such an electrode. Suchlike, a charged species may e.g. be removed (or its fraction decreased) from the stream flowing through the device, before the preferably gaseous medium leaves the device after treatment. Or, a charged species may be removed (or its fraction decreased) from the stream flowing through the device, prior to subjecting the preferably gaseous medium to said irradiation or said chemical compound, in order to improve the efficiency of these treatment(s).

According to a preferred embodiment of the present invention, such electrically conducting electrode is a porous and/or mesh-like electrode, preferably covering the whole cross-section of a flow-through passage of the device. A mesh-like and/or porous electrode may be pre-arranged in or, dependent on a determined characteristic of said medium, being either manually or automatically inserted into a flow-through passage of the device, preferably designed suchlike to on the one hand not substantially hamper the medium flowing through the device, and on the other hand provide enough conducting surface in order to attract and/or deflect charged species from the medium flowing through the device.

The method according to the invention may involve alteration of said at least one operation setting by open loop control as well as, preferably, by closed-loop control.

Control by open loop control may e.g. comprise determining a characteristic of the preferably gaseous medium to be treated or already treated and, dependent thereon, altering an operation setting. Thus, e.g. the temperature of said medium—before or after treatment—can be determined, and if the actual temperature together with the actual operation settings does not fulfil a preferably pre-determined requirement, e.g. the temperature of said medium is adjusted or an other operation setting such as e.g. the flow-through velocity is adjusted in order to fit for the determined temperature. Of course, the determination of said characteristic may be carried out before the device was actually started, or after the device was already started. If the operation setting is being altered by open loop control, the device preferably comprises or is functionally connected to a data storage means, thus allowing for preferably automatically providing a set of suitable operation settings for characteristics of said medium being determined. Moreover, the operation setting may preferably be subsequently altered automatically, too. Open loop control is preferably and most efficiently applied when the relevant characteristics of a medium to be fed to the device and treated are known to be homogeneous and stable, thus altering/adjusting the operation settings is only needed once for a given treatment problem.

According to an especially advantageous embodiment, however, alteration of said at least one operation setting is done by closed loop control. Therefore, a characteristic of the medium to be treated or already treated is continuously or in preferably regular intervals determined, and at least one operation setting is, based on said determination of a characteristic of said medium, altered continuously or in preferably regular intervals, if the characteristic of the medium is found changed and being below or above a certain intolerable threshold. Again, the alteration of said at least one operation setting, dependent on said determined at least one operation setting, is preferably aided by data storage means, contained in or functionally connected to the device, thus allowing for preferably automatically providing a set of suitable operation settings for a characteristic of said medium being determined. Suchlike, the characteristic of a preferably gaseous medium may e.g. be determined after treatment, and if said characteristic is within a preferably pre-defined, acceptable range, the operation settings are kept as they are, but if said characteristic is found to be out of a pre-defined range and/or below/above a certain pre-defined threshold, an operation setting is being altered in order to provide for said characteristic to again fulfil said pre-defined requirement of a range, threshold or the like of said characteristic.

Of course, the determination of a characteristic may be carried out, dependent on the specific treatment problem and the specific characteristic, before and/or after treatment of said medium by the device.

Of course, according to the invention the step of determining a characteristic of said medium may be carried out upstream of a first plasma-generating section and/or in between two plasma-generating sections along the flow-path of said medium and/or downstream of a last plasma-generating section. Especially if a plurality of plasma-generating sections are provided along a flow-through pass of the medium, determining of said characteristic not (only) before a first plasma generating section and/or after a last plasma-generating section, but rather especially additionally also between different plasma-generating sections offers a further control means for altering of operation settings. A much more sensitive altering of operation settings may thereby be achieved, especially separately altering of operations settings of at least one, preferably each, plasma-generating section.

The invention moreover concerns a flow-through plasma device for the treatment of a preferably gaseous medium, characterized in that it comprises means, especially a sensor for determining a characteristic of said treated or untreated medium, and means, especially a controller for altering at least one operation setting of said plasma device, dependent on said determined characteristic, wherein said means for altering at least one operation setting is not a means for modulation of the electric supply of plasma-electrodes. Preferably, said means for altering at least one operation setting is selected from the group consisting of controller for adjusting an electrical parameter of said plasma device, supplementing said preferably gaseous medium with a chemical compound, subjecting said preferably gaseous medium to irradiation, heating or cooling of said preferably gaseous medium, and combinations thereof. Besides said additional means, specially said sensor for determining a characteristic of said medium and said additional means for altering at least one operation setting, especially suitable plasma devices are disclosed in the co-pending patent applications EP 04003488.6, filed Feb. 17, 2004 and PCT/EP2005/050694, filed Feb. 17, 2005, respectively, which are incorporated herein by reference. Such plasma-devices with at least two plasma-generating sections of different polarity at a given point of time have proven especially advantageous in the context of the present invention, when upgraded and/or rebuilt with said means for determining a characteristic and said means for altering an operation setting.

According to an especially preferred embodiment, a flow-through plasma device, especially as outlined above, comprises at least one electrically conducting electrode which is arranged in or nearby the flow-through passage of said device, and which is not a tip- or counter-electrode for the generation of a plasma.

Preferably, such an electrically conducting electrode is a porous and/or mesh-like electrode, preferably covering the whole cross-section of a flow-through passage of the device. Dependent on the overall design of the device and the plasma-generating section(s), said electrically conducting electrode may be either supplied with AC or DC, or being switched from AC to DC, or vice versa, as a means of altering an operation setting according to the invention. Of course, a series of two or more of such electrically conducting electrodes may be provided, either of the same or the opposite electrical phase, and/or amplitude and/or frequency. The person of routine skill in the art may easily adopt any of the electrical parameter(s) and operation settings of the electrically conducting electrode(s) in order to solve a specific treatment problem.

According to a yet further embodiment, said device comprises means, especially a controller for alteration of said at least one operation setting by open loop control and/or closed loop control.

It is especially preferred that the preferably closed-loop controlled device comprises means for preferably continuously determining said at least one characteristic of said medium and, based on the result of said determination, means for altering said at least one operation setting. It is being understood that said means for determining at least one characteristic of said medium may advantageously be located upstream of a first plasma-generating section and/or in between two plasma-generating sections along the flow-path of said medium and/or downstream of a last plasma-generating section.

The invention further relates to a method of treating a preferably gaseous medium, comprising the steps of:
Providing a flow-through plasma device, preferably as outlined above, for flow-through treatment of said gaseous medium;
Operating said flow-through plasma device by a method as outlined above.

Moreover, the invention also concerns a method of upgrading and/or rebuilding a flow-through plasma device for the treatment of a preferably gaseous medium, comprising the steps of:
Installing means, especially a sensor for determining a characteristic of said medium;
Installing means, especially a controller for altering an operation setting of said plasma device, dependent on said determined characteristic, wherein said means for altering at least one operation setting is not a means for modulation of the electric supply of plasma-electrodes.

By simply installing said additional means for determining a characteristic of said medium, especially a sensor and said means for altering an operation setting, especially a controller, virtually any flow-through plasma device may be upgraded and/or rebuilt in order to allow for a process according to the invention being carried out with such device.

Moreover, the invention proved especially suitable for upgrading and/or rebuilding especially big and complex air conditioning devices by simply installing means for determining a characteristic of said medium, preferably a sensor; and installing means for altering an operation setting of said plasma device, preferably a controller, dependent on said determined characteristic.

The invention is henceforth explained in more detail on the basis of preferred embodiments, without the invention being limited thereto:

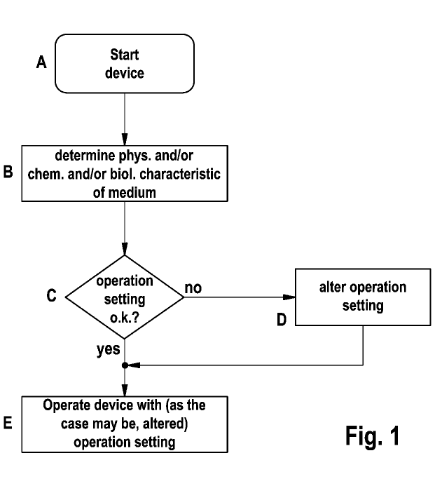

FIG. 1: Flow-chart for open-loop control of a flow-through plasma device, exemplarily;

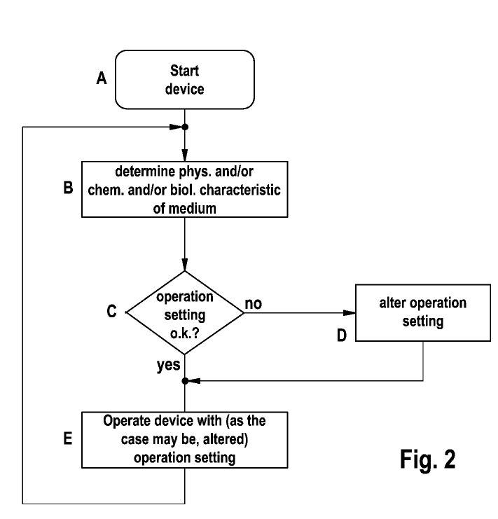

FIG. 2: Flow-chart for close-loop control of a flow-through plasma device, exemplarily;

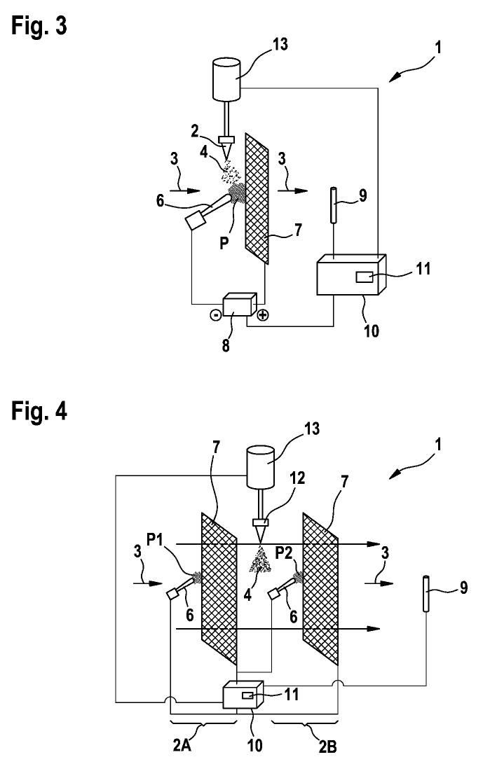

FIG. 3: Flow-through plasma device with means for determining a characteristic of a medium and means for altering an operation setting, exemplarily;

FIG. 4: Flow-through plasma device with two plasma-generating sections, and with means for determining a characteristic of a medium and means for altering an operation setting, exemplarily;

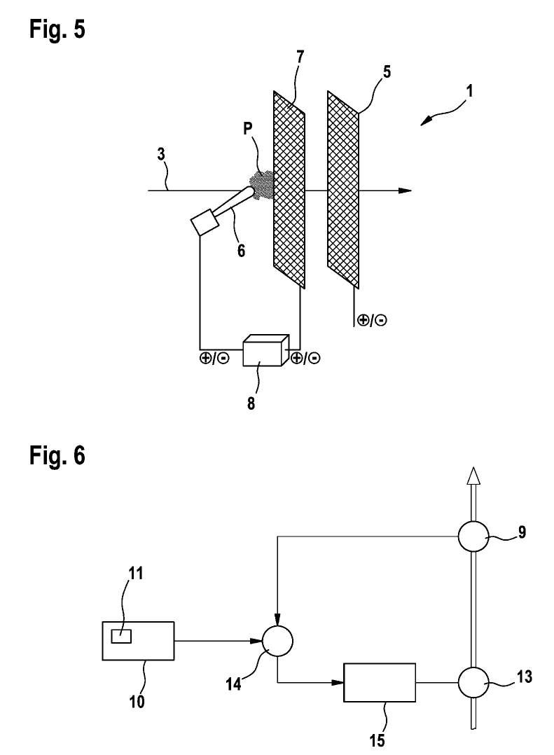

FIG. 5: Flow-through plasma device with an electrode, which is not a tip- or counter-electrode for the generation of a plasma;

FIG. 6: Circuit diagram of closed-loop control.

FIG. 1 exemplarily shows a flow-chart for open-loop control of a flow-through plasma device according to the present invention. In step A, the device is being started by any conventional means. Next, a physical, chemical or biological characteristic of a medium to be treated or already treated by the device is determined in step B. Most preferably, said characteristic is directly an indicator of the treatment being effective or not, e.g. a biological activity indicating the sterilizing effect, a characteristic absorption of a compound indicating the presence and/or quantity of a compound in the medium, or the like. In contrast thereto, the characteristic of said medium may also be a secondary indication for the treatment being effective or not, in case when sufficient knowledge is available about the correlation of such secondary indication and the effectiveness of the treatment. Exemplarily, it might be known that a certain temperature range of the medium to be treated must be assured for the treatment being effective; then the temperature of said medium to be treated might thus be adjusted before treatment as a means of adjusting an operation setting. Dependent on the chosen characteristic of the medium being determined, it may prove useful to determine said characteristic either before or after treatment of said medium, before and after treatment, or even between different treatment steps, e.g. different plasma-generating sections. Preferably, the characteristic of said medium is determined at least once after treatment by the device. In step C, it is checked whether the operation settings are suitable or not, i.e. if the desired treatment result is achieved/achievable or not, based on the determined physical, chemical or biological characteristic of said medium. If it is found that the desired operation settings are to be altered in order to allow for an efficient treatment (e.g. based on a pre-defined threshold or range of said characteristic to be achieved), at least one operation setting is altered in step D. The choice of the operation setting being altered and the grade of alteration of said operation setting may advantageously be aided by a data storage means, operatively connected to the device and providing suitable sets of operation settings for given treatment problems and/or determined characteristics of a medium. In step E, the device is subsequently operated with (as the case may be, altered) operation settings. Such open-loop control proves especially suitable for treatment problems which are known to not being prone to substantial changes of characteristics of the medium to be treated, which changes might otherwise hamper the effectiveness of the treatment.

As outlined in FIG. 2, the invention may also be carried out with closed-loop control, proving especially advantageous for an continuous control of the output of a device with respect to the effectiveness of a treatment. Thereupon, the treated medium is continuously or in preferably regular intervals checked whether a given characteristic, indicating the effectiveness of the treatment, is satisfying or not. If necessary, at least one operation setting is then either altered in order to re-achieve a satisfying treatment result, or the operation settings are kept as they are, if the treatment result is satisfactory.

FIG. 3 exemplarily shows a flow-through plasma device 1 for the treatment of a preferably gaseous medium 3 with a plasma P, preferably a corona plasma. For the sake of graphical clarity, a housing of the flow-through device is not shown. Such corona plasma is preferably generated, as known in the art, by suitably designed and arranged electrodes such as a tip-like electrode 6 and a counter-electrode 7 such as a mesh-like grid. The electrodes 6 and 7 are connected to a suitable power supply 8, in order to supply electrodes 6 and 7 with either DC or AC, or alternatively AC or DC. According to the invention, a means, especially a sensor 9 for determining a characteristic of said medium 3 is e.g. arranged downstream of a treatment step with a plasma P; especially for open-loop control, said sensor 9 for determining a characteristic may however also be arranged upstream of said plasma (P) treatment. Functionally connected to said sensor 9 for determining a characteristic of said medium (3), a controller 10 is advantageously provided (either external to or integral with the device 1), preferably together with a data storage means 11. Most preferably, the controller controls the whole device 1 preferably automatically, especially also the power supply 8. Based on said determined characteristic and upon comparison with data provided in said data storage means 11, the controller identifies whether the treatment result is tolerable or not. If the treatment result is not tolerable or suitably improvable, the controller may direct the device 1 to alter an operation setting. Exemplarily in FIG. 3, a chemical compound 4 is supplemented to the medium (3) to be or already treated, preferably suchlike that it also gets in contact with the plasma P. Such chemical compound may e.g. be provided in a storage tank 13 and be supplemented via a nozzle 12. Suitable chemical compounds are e.g., but not limited thereto, electronegative gases, electropositive gases, vapour of polar liquids, and mixtures thereof. It is to be understood, that additionally or alternatively to supplementing a chemical compound 4, any other suitable operation setting may be altered as outlined above, such as e.g. subjecting the medium to irradiation or electrically deflect and/or attract ionic species.

A further embodiment of the present invention is illustrated in FIG. 4, with two plasma-generating sections 2A and 2B in series, generating two plasmas P1 and P2, respectively. In FIG. 4, a power supply is integral with the controller 10. Again, a means for determining a characteristic of said medium 3 is provided downstream of a final plasma-generating section 2B but, in contrast to FIG. 3, a chemical compound 4 is supplemented to the medium 3 in between the two plasma-generating sections 2A, 2B. Suchlike, different operation settings may e.g. be altered in between or in different plasma-generating sections, either independently or dependent from each other. Suitable sets of operation setting for multiple plasma-generating sections or the space there between may again be advantageously provided by a controller 10 and a suitable data storage means 11.

FIG. 5 shows an electrically conducting electrode, which is not an electrode involved in the generation of a plasma P, such as the tip-like electrode 6 and the counter-electrode 7, both connected to a suitable power supply 8. A preferably gaseous medium 3 is treated in the device. The electrically conducting electrode, here a mesh-like electrode preferably covering the whole cross-section of the flow-through passage, may be either supplied with AC or DC, and power supply may be altered as a means of altering an operational setting according to the invention. If the electrode 5 is e.g. positively (negatively) charged at a given point of time, negative (positive) ions are accelerated towards the electrode 5 from the plasma P, and positive (negative) ions are repelled, thus providing a simple and convenient means for influencing the composition of reactive species of the plasma P.

A general circuit diagram of closed-loop control in the context of the present invention is exemplarily shown in FIG. 6. The flow-through passage is schematically represented by the double-lined arrow. A controller 10 comprises or is operatively connected to a suitable data storage means 11, thereby providing a desired value (or threshold or acceptable range or the like, dependent on the specific treatment problem) of said characteristic of said medium to be treated and/or already treated. Said controller 10 is coupled to a comparator 14, continuously or in especially regular intervals receiving input from a sensor 9, indicating the determined characteristic of said medium. The comparator 14 continuously or in especially regular intervals compares if the measurand is acceptable, i.e. fulfils the above-mentioned acceptable ranges or thresholds. If the comparator 14 finds the desired value not being fulfilled, it directs the alteration of at least one operation setting, e.g. the supplementing of a chemical compound comprised in e.g. a storage tank 13. Such alteration of an operation setting may e.g. comprise action of a further regulator 15, or may be preferably governed by the controller 10.

1-26. (canceled)

27. A method of operating a flow-through plasma device with at least one plasma-generating section for the treatment of a fluid medium, said method comprising the steps of:
determining at least one characteristic of said medium;
dependent on said determined characteristic, altering at least one operation setting of said plasma device, other than a modulation of the alternating current or voltage supplied to the plasma-electrodes.

28. A method according to claim 27, wherein the altering of said operation setting comprises a step chosen from the group consisting of adjusting an electrical parameter of said plasma device, supplementing said preferably gaseous medium with a chemical compound, subjecting said preferably gaseous medium to irradiation, heating or cooling of said preferably gaseous medium, and combinations thereof.

29. A method according to claim 28, wherein the chemical compound, which is supplemented to the preferably gaseous medium, is chosen from the group consisting of electronegative gases, electropositive gases, vapor of polar liquids, and mixtures thereof.

30. A method according to claim 28, wherein the irradiation is chosen from the group consisting of the UV spectral range, ionizing radiations, particle beams, and photons from an external plasma source.

31. A method according to claim 28, wherein the adjusted electrical parameter is a voltage and/or current, and/or a frequency thereof, respectively, which is supplied to an electrically conducting electrode in or nearby the flow-through passage of said device, which is not a tip- or counter-electrode for the generation of a plasma.

32. A method according to claim 31, wherein the electrically conducting electrode is a porous and/or mesh like electrode.

33. A method according to claim 27, wherein said characteristic of said medium is chosen from the group consisting of temperature, spectral absorption, spectral emission, moisture content, droplet size, particle content, particle size, a biological activity, the composition of said medium or an indication of said composition of said medium, the temperature of said medium, or combinations thereof.

34. A method according to claim 27, wherein alteration of said at least one operation setting is done by open loop control.

35. A method according to claim 27, wherein alternation of said at least one operation setting is done by closed loop control.

36. A method according to claim 35, wherein at least one characteristic of the treated medium is determined and, dependent on the result of said determination, said operation setting is altered.

37. A method according to claim 36, wherein at least one characteristic of the treated medium is continuously determined.

38. A method according to claim 37, wherein the operation settings of the device remain unchanged as long as said at least one determined characteristic remains below or above a predefined acceptable threshold.

39. A method according to claim 27, wherein the step of determining a characteristic of said medium is carried out upstream of a first plasma-generating section and/or between two plasma-generating sections along the flow-path of said medium and/or downstream of a last plasma-generating section.

40. A method according to claim 27, wherein operation settings are differently altered, dependent on said determined characteristic, in different sections of the flow-through passage of the device.

41. A method of treating a fluid medium, comprising the steps of:
providing a flow-through plasma device, for flow-through treatment of said gaseous medium;
operating said flow-through plasma device by a method according to claim 27.

42. A flow-through plasma device, wherein an electrically conducting electrode is arranged in or nearby the flow-through passage of said device, which is not a tip- or counter-electrode for the generation of a plasma, especially a corona plasma.

43. A flow-through plasma device according to claim 42, wherein said electrically conducting electrode is a porous or mesh-like electrode.

44. A flow-through plasma device for the treatment of a fluid medium, said device comprising a sensor for determining a characteristic of said treated or untreated medium, and a controller for altering at least one operation setting of said device, dependent on said determined characteristic, wherein said controller alters an operation setting other than modulation of the alternating current or voltage supplied to the plasma-electrodes.

45. A flow-through plasma device according to claim 44, wherein said controller for altering at least one operation setting is selected from the group consisting of means for adjusting an electrical parameter of said plasma device, supplementing said preferably gaseous medium with a chemical compound, subjecting said fluid medium to irradiation, heating or cooling of said fluid medium, and combinations thereof.

46. A flow-through plasma device according to claim 44, further comprising a controller for alteration of said at least one operation setting by open loop control.

47. A flow-through plasma device according to claim 44, further comprising a controller for alteration of said at least one operation setting by closed loop control.

48. A flow-through plasma device according to claim 47, further comprising a sensor for determining said at least one characteristic of said medium and, based oh the result of said determination, altering said at least one operation setting.

49. A flow-through plasma device according to claim 44, further comprising a sensor for determining at least one characteristic of said medium upstream of a first plasma-generating section and/or in between two plasma-generating sections along the flow-path of said medium and/or downstream of a last plasma-generating section.

50. A method of upgrading and/or rebuilding a flow-through plasma device for the treating a fluid medium comprising the steps of:
installing a sensor for determining a characteristic of said medium;
installing a controller for altering an operation setting of said plasma device, dependent on said determined characteristic, wherein said controller alters an operation setting other than modulation of the alternating current or voltage supplied to the plasma-electrodes.

51. A method of upgrading and/or rebuilding an air conditioning device, comprising the step of installing a flow-through plasma device according to claim 41.

52. Air conditioning device, further comprising a flow-through plasma device according to claims 41.
